(19) United States
(12) Patent Application Publication
(10) Pub. No.: US 2007/0076235 A1
(43) Pub. Date: Apr. 5, 2007

(54) Image forming apparatus and printing method thereof

(75) Inventor: Kazumi Murata, Shizuoka-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/231,209

(22) Filed: Sep. 19, 2005

(51) Int. Cl. G06F 3/12

(52) U.S. Cl. 358/1.13

(57) ABSTRACT

An image forming apparatus according to this invention comprises: a printer unit for printing and outputting image data; a mode setting unit for setting a print mode to the printer unit, said mode setting unit having an operating unit that can be operated by a user; a submitting unit for submitting recommended modes which are some of print modes relating to a specific job-setting item when the user input the specific job-setting item by operating the operating unit to set the print mode; and a control unit for controlling the printer unit, causing the printer unit to print and output the image data in a mode selected from the recommended modes presented by the submitting unit.

### BACKGROUND OF THE INVENTION

1. Field of the Invention

The present invention relates to an image forming apparatus such as a digital multi-function peripheral (MFP), a copier or a printer, and a printing method for use in the image forming apparatus. More particularly, the invention aims at enhancing the maneuverability of the apparatus and method.

2. Description of the Related Art

In the image forming apparatus, such as a digital multi-function peripheral (MFP), can function not only as a copier, but also as a printer that can print image data generated in personal computers (PCs) if connected to the PCs by a network.

The image forming apparatus, such as a copier, must be set to various operating modes in order to perform a copying process. To print data, the desired magnification is set, the desired paper size is selected, the one-sided printing or two-sided printing is selected, the N-in-1 printing (printing of several pages on a single paper sheet) is set, and the desired printing density is set. After the printing is performed, stapling and/or punching may be carried out. To accomplish these post-printing processes, it is necessary to set the stapling position and the punching position.

In view of this, in general, image forming apparatuses are set to a standard operating mode that is most frequently used, in which the magnification is 100%, paper size is A4, one-sided printing is designated, automatic printing-density is selected and non-sorting is selected. To operate the apparatuses in any mode other than the standard mode, however, the user need to set various mode items individually, spending much time.

Jpn. Pat. Appln. Laid-Open Publication No. 2000-307781 (corresponding to U.S. Pat. No. 6,285,842 B1) describes an image forming apparatus in which image-forming conditions set, such as paper size, can be recognized with ease hand in a short time. In this prior art, the operation panel of the copier has a display. To make a copy of an original, the display displays two icons side by side. One icon schematically represents the original, and the other icon schematically represents a copy paper sheet. If the original has size larger than the copy paper sheet, the display displays a message telling that the entire original cannot be copied on the paper sheet. The display displays other messages, prompting the user to change the paper sheet to another and to change the copy magnification.

Hence, the user can change the copy magnification and select desired paper sheets, while seeing the display screen. In addition, the user can select a stapling position and a punching position to perform stapling and punching, i.e., post-printing processes, just looking at the images displayed on the screen.

The prior art is indeed advantageous in that the user can set copy modes, while looking at the icons displayed on the screen. However, the prior art is not so useful, because it takes the user much time to set various copy modes because he or she needs to select and input them, one item by one item.

### BRIEF DESCRIPTION OF THE DRAWINGS

FIG. 1 is a block diagram showing the entire configuration of an image forming apparatus according to an embodiment of this invention;

FIG. 2 is a diagram depicting the operation panel of the image forming apparatus according to the embodiment of the invention;

FIG. 3 is a flowchart explaining how various print modes are set in the image forming apparatus according to the embodiment of the invention;

FIG. 4 is a diagram illustrating an example of an initial menu displayed on the operation panel of the image forming apparatus according to the embodiment of this invention;

FIG. 5 is a diagram showing an example of a menu that is displayed when “Application,” i.e., one of the print-job items, is selected and input in the image forming apparatus according to the embodiment of this invention;

FIG. 6 is a diagram showing an example of a menu that is displayed when “Recommended Setting,” i.e., one of the print-job items, is selected and input in the image forming apparatus according to the embodiment of this invention;

FIG. 7 is a diagram showing an example of a menu that is displayed when “Number of copies,” i.e., one of the print-job items, is selected and input in the image forming apparatus according to the embodiment of this invention;

FIG. 8 is a diagram showing an example of a menu that is displayed when “Two-sided Printing,” i.e., one of the print-job items, is selected and input in the image forming apparatus according to the embodiment of this invention;

FIG. 9 is a diagram showing an example of a menu that is displayed when “Distribution,” i.e., one of the print-job items, is selected and input in the image forming apparatus according to the embodiment of this invention;

FIG. 10 is a diagram illustrating an example of another initial menu displayed on the operation panel of the image forming apparatus according to the embodiment of this invention; and

FIG. 11 is a diagram showing an example of the detail setting menu to which the initial menu of FIG. 10 has been switched in the image forming apparatus according to the embodiment of this invention.

### DETAILED DESCRIPTION OF THE PREFERRED EMBODIMENTS

Throughout this description, the embodiments and examples shown should be considered as examples, rather than limitations on the apparatus of the present invention.

An embodiment of the present invention will be described in detail, with reference to the accompanying drawings.

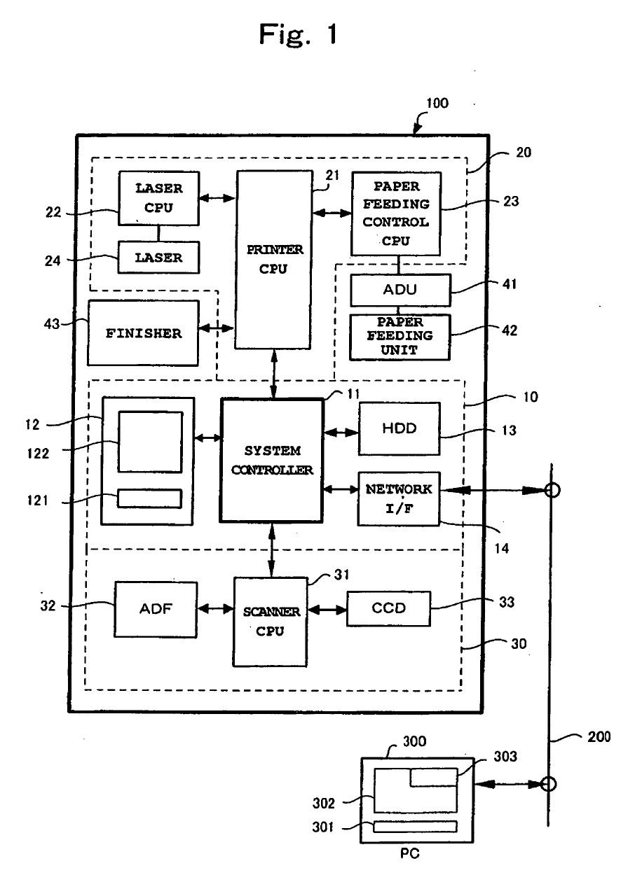

FIG. 1 shows an image forming apparatus 100 that is a digital multi-function peripheral (MFP). The image forming apparatus 100 can be connected to an external apparatus 300 such as a personal computer (PC), through a network 200 such as a local area network (LAN). The following description is based on the assumption that the image forming apparatus 100 and the external apparatus 300 are an MFP and a client PC, respectively.

The image forming apparatus 100 has an image data processing unit 10, a printer unit 20, and a scanner unit 30. The image data processing unit 10 has a system controller 11, an operation panel 12, and a hard disk drive (HDD) 13. The system controller 11 stores software that controls the other components of the unit 10. The operation panel 12 is connected to the system controller 11. The HDD 13 is a storage device. The image data processing unit 10 further has a network interface (I/F) 14, which connects the system controller 11 to the PC 300 and the like via a LAN 200.

The operation panel 12 can be operated by the user. It has an input unit 121 that is operated to input various instructions to the system controller 11. The operation panel 12 has a display 122, which can display various data items.

The HDD 13 is a storage medium that temporarily stores the print data generated by the PC 300, the data read by the scanner unit 30 and some other data. The printer unit 20 has a printer CPU 21, a laser CPU 22, and a paper feeding control CPU 23. The CPUs 21, 22 and 23 are connected to one another. The printer CPU 21 controls the printer unit 20, cooperating with the system controller 11.

The laser CPU 22 controls a laser 24. It controls the emission of a laser beam from the laser 24, which scans the photosensitive body to form an image. The paper feeding control CPU 23 controls an automatic paper feeding unit (ADU) 41 and a paper feeding unit 42, so that paper sheets may be fed to undergo one-sided printing or two-sided printing. The printer CPU 21 controls a finisher 43. The finisher 43 first performs stapling, punching or saddle stitching and then feeds out of the image forming apparatus 100.

The scanner unit 30 has a scanner CPU 31, an automatic document feeder (ADF) 32, and a CCD 33. The scanner CPU 31 controls the other components of the scanner unit 30, cooperating with the system controller 11. Using an exposure lamp, the scanner unit 30 irradiates the original placed on the original table. The CCD 33 receives the light reflected from the original, reads the image printed on the original and converts the image into image data. The ADF 32 is a device that feeds originals onto the original table, one after another.

The client PC 300 provides print data. It has a data generating unit 301 and a printer driver 302. The data generating unit 301 uses application software, generating print data resubmitting texts and figures. The printer driver 302 receives the image data from the data generating unit 301 and outputs the image data as page-describing language (PLD) data to the image forming apparatus 100 via the network 200. The printer driver 302 has an input unit 303, which can input instructions such as print request to the MFP 100.

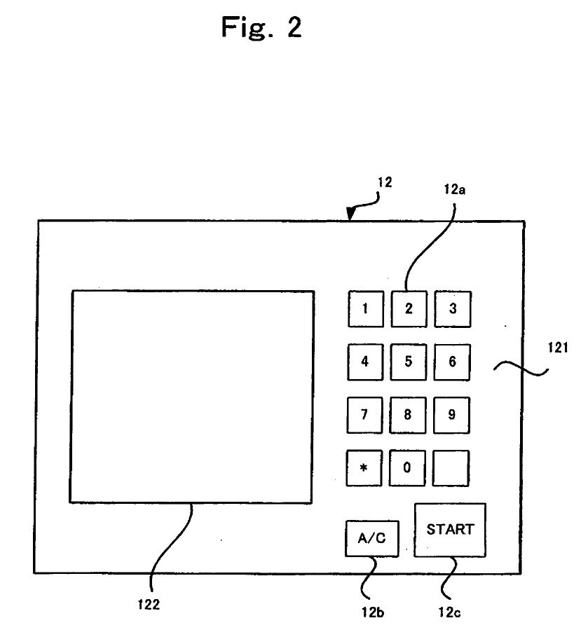

FIG. 2 shows an example of the operation panel 12. The input unit 121 has keys 12a, a clear key 12b, and a start key 12c. When pushed, the keys 12a input, for example, the number of copies to make. When depressed, the clear key 12b cancels any erroneous inputs. When pushed, the start key 12c instructs that the printing sequence be started. The operation panel 12 has a display 122 of touch-panel type. When the user touches the items displayed on the display 122, various image-forming conditions are set, such as paper size, one- or two-sided printing, stapling, and punching and the like. Thus, the system controller 11 controls the printer unit 20 in the print mode desired by the user, in accordance with the operation of the touch panel, the operation of the start key, and the like.

This invention is characterized in that the display 122 displays some recommended print modes when the user places an original on the original table of the scanner unit 30 and operates the operation panel 12, inputting some of the items displayed. Then, the user can select the desired print mode from the recommended copy modes.

The print modes include modes directly related to printing, such as one-sided printing, two-sided printing and N-in-1 mode, and process modes for post-printing process, such as stapling, punching and saddle stitching (bookbinding) that the finisher performs. In the following description, these modes will be generally called print modes. The recommended modes are those of the print modes, which are preset and used in any possible combination in order to output data in any state the user desires.

The user can set any desired print mode by performing an easy operation. The user need not select many items as with the conventional image forming apparatus, before he or she can set a desired print mode. The user can of course set a mode in detail if the desired print mode is not included in the recommended copy modes.

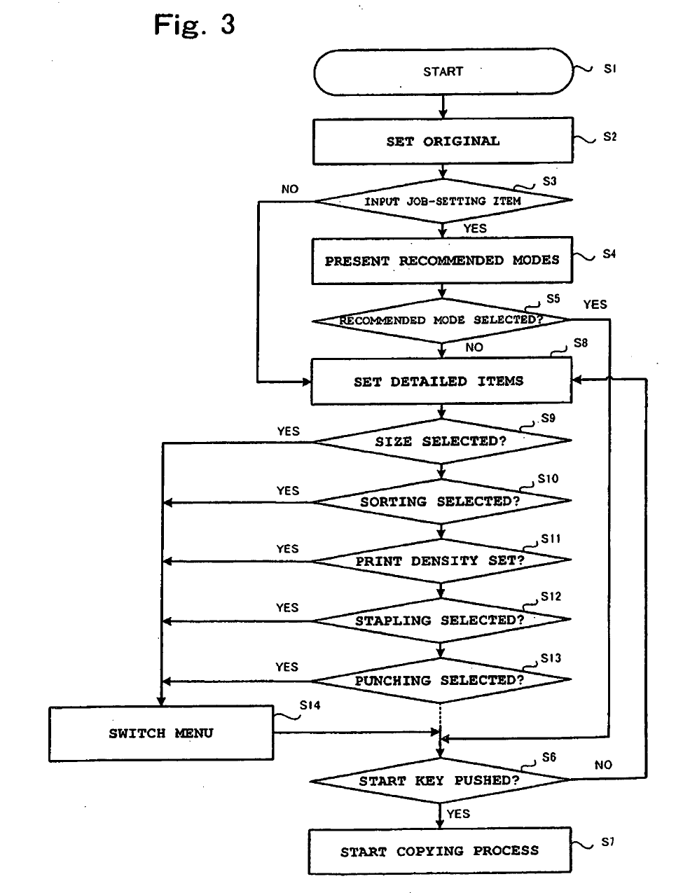

How the image forming apparatus that is an embodiment of this invention operates as a whole will be described, with reference to the flowchart of FIG. 3.

FIG. 3 is a flowchart explaining how the scanner unit 30 reads an original, thereby to copy the original. Step S1 is the start step. In Step S2, the user sets the original on the original table of the scanner unit 30. In Step S3, it is determined whether a specific print-job item has been input or not. The specific print-job item is a job-setting item that has been selected from the job-function setting menu displayed by the display 122 of the operation panel 12. That is, it is determined whether the user has touched (or selected) the job item.

If the specific print-job item has been selected (if YES), the display 122 of the operation panel 12 displays a menu of modes recommended for the copying process in Step S4. Thus, several icons of recommended copy modes are displayed. In Step S5, the user selects a desired print mode from the icons displayed. Once the user has selected a recommended mode, the flow goes to Step S6, in which it is determined whether the start key 12c has been depressed or not. If the user has depressed the start key 12c, the printing process and the post-printing process are carried out in Step S7, in the recommended mode that has been selected. Thus, the copying process is performed.

If the icons presented in Step S4 do not include the desired recommended mode and if no recommended modes are selected in step S5 or it is determined in Step S6 that the start key 12c has not been depressed, the flow goes to Step S8. In Step S8, a mode can be set in detail. Thus, the print mode the user desires can be set in Steps S9 to S13, which will be described below.

The user can set the paper size in Step S9, sorting in Step S10, the printing-density in Step S11, stapling in Step S12, and punching in Step S13. If these items are set in Steps S9 to S13, respectively (if YES), the menu displayed on the display 122 is changed to another, displaying the contents of the items set in these steps. Then, the copying process is performed in Step S7 if it is determined in Step S6 that the start key 12c has been depressed.

Incidentally, in Steps S9, S10, S11, S12 and S13, the standard mode has already been set. If the user switches the standard mode to another mode (if YES), the flow goes to Step S14. If the user does not switch the standard mode to another, the process is carried out in the standard mode until the flow proceeds to Step S6. If the user needs to set additional items in detail, a step to perform after Step S13 is added.

The user can thus set print modes while looking at the screen of the display 122. In addition, recommended modes are displayed when the user inputs a few items. The user can therefore select the mode he or she desires, from the recommended modes. Hence, the copying process can be carried out, without setting modes in detail in such a way as is required with the conventional apparatus. If the desired mode is not included in the recommended modes, the user can set the desired mode in detail as with the conventional image forming apparatus.

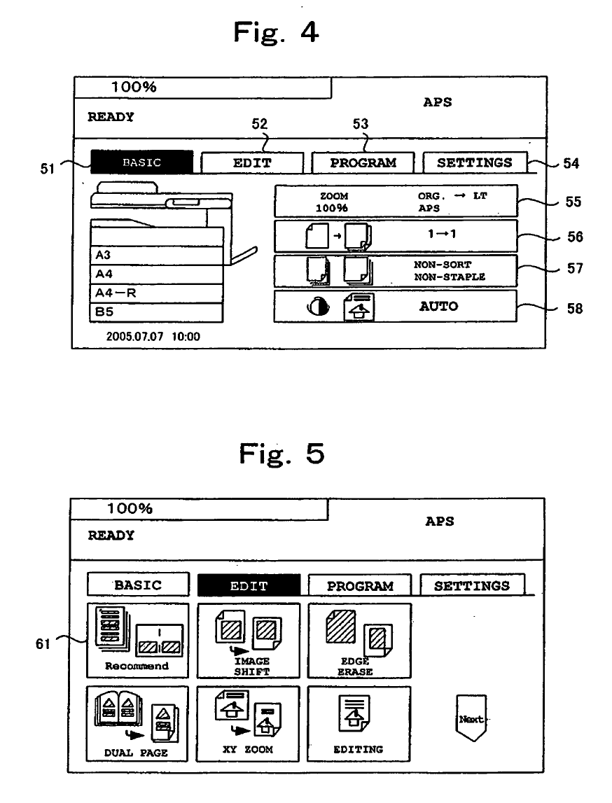

How print modes are set in the image forming apparatus according to an embodiment of this invention will be described, with reference to FIG. 4 et seq. and the step numbers shown in FIG. 3.

FIG. 4 illustrates an initial menu that the display 122 displays when the user sets an original (Step S1, S2). The menu displayed on the display screen is a job-function setting menu. The job-function setting menu has a plurality of job items 51, 52, 53 and 54, which are, for example, “BASIC”, “EDIT”, “PROGRAM” and “SETTINGS”.

When the user selects, for example, the job item 51, “BASIC” in the screen, as illustrated in FIG. 4, the display 122 displays such a low-layer menu as depicted in FIG. 5. The low-layer menu has a plurality of icons. These icons include an icon 61 of a “Recommend”.

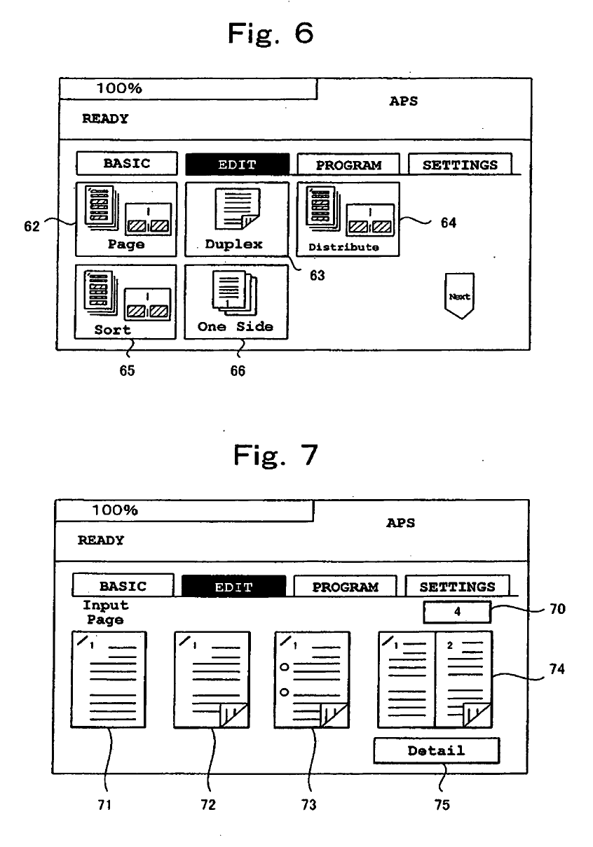

If the user selects the icon 61 of the “Recommend”, the display 122 displays such a recommended-setting menu as shown in FIG. 6. The recommended-setting menu has print-job setting icons 62, 63, 64, 65 and 66, i.e., “Page”, “Duplex”, “Distribute”, “Sort” and “One Side”.

Assume that the user selects the icon 62, i.e., “Page” (Step S3). Then, the recommended modes are displayed in the form of icons, as shown in FIG. 7 (Step S4).

As FIG. 7 shows, an input item 70 is displayed, enabling the user to input the number of copies desired. The user may input “2” to have two copies, or “4” for four or more copies. If the user inputs “4”, a plurality of icons 71 to 75 will be displayed as shown in FIG. 7.

The icon 71 represents a mode of carrying out stapling in the one-side printing. The icon 72 indicates a mode of performing stapling in the two-sided printing. The icon 73 indicates a mode of carrying out stapling and punching in the two-sided printing. The icon 74 indicates a mode of performing 2-in-1 process (A3 paper sheet) and stapling in the two-sided printing. The user selects a desired icon from of these icons 71 to 74 (Steps S5). Then, the user pushes the start key 12c, whereby the copying process is carried out (Steps S6 and S7). Thus, the user can set any desired modes, by performing a minimum input operation.

The display 122 displays four icons 71 to 74 as is illustrated in FIG. 7. It may display additional icons of 4-in-1 print mode and saddle stitching mode. Further, it may display an icon of non-stapling mode.

FIG. 7 illustrates the case where four or more copies are made. If the user inputs “2” for two copies and selects the two-sided printing, stapling need not be carried out. In this case, the icon 72 shown in FIG. 7 is switched to an icon that represents the non-stapling mode. Similarly, stapling need not be performed in the 2-in-1 print mode. Hence, the print mode icon is switched when the number of copies is changed from “2” to “4”, and vice versa.

Two recommended modes for setting “number of copies,” i.e., “2” and “4”, are displayed as described above. This facilitates the selection on the part of the user. That is, to set the number of copies desired, one of only two choices (i.e., two copies and four or more copies) is set because it is not wise to count copies one by one. This enhances the convenience for the user.

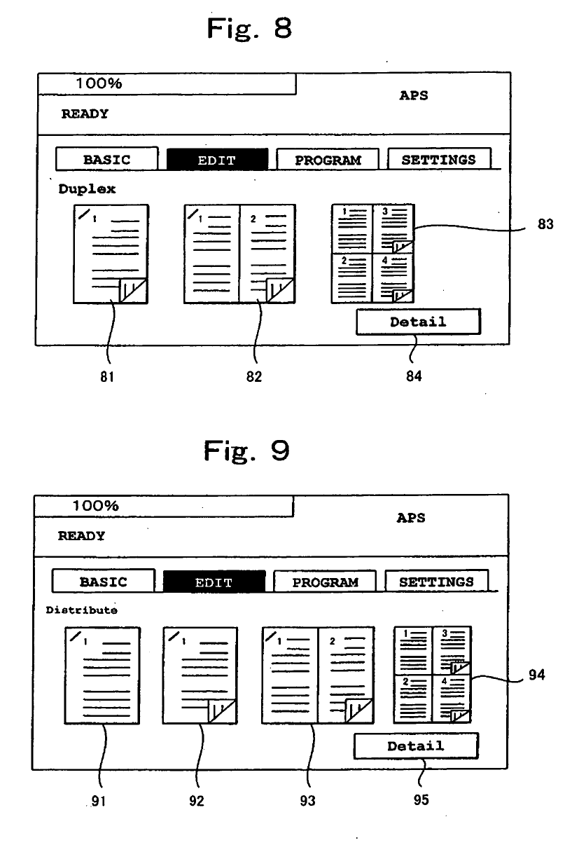

In the menu shown in FIG. 7, the user may select the item 63, i.e., “Duplex”. Then, such recommended modes as shown in FIG. 8 will be displayed as icons. If the user selects the item 64, i.e., “Distribute”, such recommended modes as shown in FIG. 9 will be displayed as icons.

The recommended modes for “Duplex” shown in FIG. 8 are in a menu for the two-sided copying process. The icon 81 indicates the mode of performing stapling in the two-sided printing. The icon 82 indicates the mode of performing stapling in the two-sided printing and performing the 2-in-1 process (A3 paper sheet). The icon 83 represents the mode of performing no stapling and performing the two-sided printing in the 4-in-1 process.

In the menu of “Distribute” shown in FIG. 9, icons are displayed, which can be well recognized as documents to be distributed in such a way as to save resources. The icon 91 indicates the mode of performing stapling in the one-sided printing. The icon 92 represents the mode of performing stapling in the two-sided printing. The icon 93 indicates the mode of carrying out the 2-in-1 process (A3 paper sheet). The icon 94 indicates the mode of performing no stapling and performing the two-sided printing in the 4-in-1 process (A3 paper sheet).

Not only for “Page”, “Duplex” and “Distribute”, but also the items 65 and 66, i.e., “Sort” and “One Side” shown in FIG. 7, are displayed as icons of recommended modes such as stapling, N-in-1, and saddle stitching. The user can select any one of these icons displayed. Further, icons of “energy-saving modes” may be displayed. More precisely, additional modes, such as N-in-1 print mode, low-density print mode and paper-size reducing mode of switching A3 size to A4 size, may be displayed.

Thus, the user can select any desired mode from the recommendable modes. If none of the menus shown in FIGS. 7, 8 and 9 include the print mode that the user desires, the user may select the icon 75, 84 or 95 for “Detail”. Then, the display 122 displays the initial menu shown in FIG. 4 (Step S8). The user can then select the basic-job items 55, 56, 57 and 58 from the basic screen to set various print modes, respectively (Steps S9 to S14).

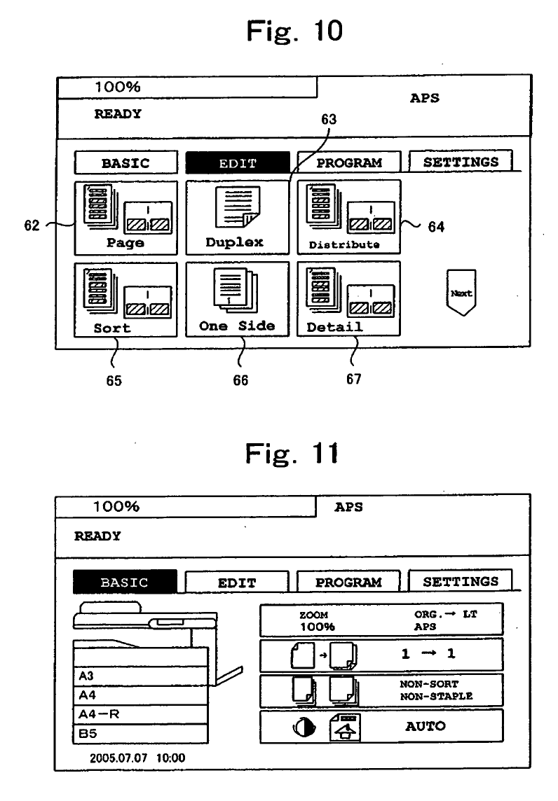

FIG. 10 is a diagram illustrating an example of another initial menu that the display 122 can display in the image forming apparatus according to an embodiment of this invention. This initial menu immediately shows the recommended modes. The initial menu is identical to the initial menu of FIG. 6, except that an icon 67, “Detail” is added. When the icon 67, or “Detail” is selected, the menu is switched to the menu shown in FIG. 11 (which corresponds to the menu of FIG. 4). With the image forming apparatus according to this invention, the user only need to select a desired print mode form several recommended modes, and data is then printed in the desired print mode. The apparatus is therefore useful, and any print mode set can be well recognized.

Although an exemplary embodiment of the present invention has been shown and described, it will be apparent for those having ordinary skill in the art that a number of changes, modifications, or alterations to the invention as described herein may be made, none of which depart from the spirit of the present invention. All such changes, modifications, and alterations should therefore be seen as within the scope of the present invention.

For example, the image forming apparatus according to this invention has been described as an MFP 100. Needless to say, this invention can be applied an image forming apparatus such as a printer.

In the embodiment described above, the scanner unit 30 reads the original so that the apparatus may make a copy of the original. Instead, the display unit of the client PC 300 may display such a menu as shown in FIG. 4, which is switched to any one of the menus shown in FIGS. 5 to 9 when a print is input to the MFP 100. The image forming apparatus 100 can therefore be set to the print mode. Hence, the image forming apparatus 100 can be set to any print mode selected from the recommendable modes and can then print the image data output to it from the client PC 300 via the network 200.

What is claimed is:

1. An image forming apparatus having a printing function comprising:
a printer unit for printing and outputting image data;
a mode setting unit for setting a print mode to the printer unit, said mode setting unit having an operating unit that can be operated by a user;
a submitting unit for submitting recommended modes which are some of print modes relating to a specific job-setting item when the user input the specific job-setting item by operating the operating unit to set the print mode; and
a control unit for controlling the printer unit, causing the printer unit to print and output the image data in a mode selected from the recommended modes presented by the submitting unit.

2. The image forming apparatus according to claim 1, wherein the mode setting unit enables the user to set a print mode when the recommended modes presented by the submitting unit do not include one that the user desires.

3. The image forming apparatus according to claim 1, wherein, when an input is made as the specific job-setting item, designating a number of prints to make, the submitting unit displays an icon for the recommended mode that accords with the number of prints.

4. The image forming apparatus according to claim 3, wherein the number of prints is designated by inputting a value resubmitting either two prints or at least four prints.

5. The image forming apparatus according to claim 1, wherein, when an input is made as the specific job-setting item, designating either one-sided printing or two-sided printing, the submitting unit displays an icon for the recommended mode that accords with the one-sided printing or two-sided printing.

6. The image forming apparatus according to claim 1, wherein, when an input is made as the specific job-setting item, designating documents to be distributed, the submitting unit displays an icon for the recommended mode that accords with the documents to be distributed.

7. The image forming apparatus according to claim 1, wherein, when an input is made as the specific job-setting item, designating saving of resources, the submitting unit displays an icon for the recommended mode that accords with the saving of resources.

8. The image forming apparatus according to claim 1, wherein the recommended modes are displayed as icons that represent one-sided printing, two-sided printing and N-in-I printing and icons that represent post-printing processes including stapling and punching.

9. The image forming apparatus according to claim 1, wherein the submitting unit includes a touch panel display, the touch panel display displays a plurality of print-job setting items, and any one of the print-job setting items displayed can be touched and selected.

10. An image forming apparatus that can be connected to an external apparatus via a network, comprising:
a printer unit for printing and outputting image data containing print data transmitted from the external apparatus via the network;
a mode setting unit for setting a print mode to the printer unit, said mode setting unit having an operating unit that can be operated by a user;
a submitting unit for submitting recommended modes which are some of print modes relating to a specific job-setting item when the user input the specific job-setting item by operating the operating unit to set the print mode; and
a control unit for controlling the printer unit, causing the printer unit to print and output the image data in a mode selected from the recommended modes presented by the submitting unit.

11. The image forming apparatus according to claim 10, wherein the external apparatus is a client PC.

12. A printing method using an image forming apparatus that has a submitting unit and a mode setting unit for printing, said method comprising:
displaying a menu for inputting print-setting items, as an initial menu;
displaying a plurality of recommended modes, in accordance with a print-setting item input;
displaying, when any one of the recommended modes is selected, a menu for selecting a desired print mode in accordance with the recommended mode selected; and
carrying out printing in the desired print mode selected.

13. The print method according to claim 12, wherein, when the recommended modes presented by the submitting unit do not include a print mode that a user desires, the user operates the mode setting unit to set the print mode.
